(19) United States
(12) Patent Application Publication
(10) Pub. No.: US 2020/0108736 A1
(43) Pub. Date: Apr. 9, 2020

(54) PITCH AND SLIDE SEAT LATCH WITH TOLERANCE AND FREEPLAY COMPENSATION FEATURE

(71) Applicant: MAGNA CLOSURES INC., Newmarket (CA)

(72) Inventors: Daniel Biasi da SILVA, Sao Paulo (BR); Renato Ramos Jannuzzi, Sao Paulo (BR); Josemar de Melo Dornelas, Sao Paulo (BR)

(21) Appl. No.: 16/583,250

(22) Filed: Sep. 25, 2019

Related U.S. Application Data
(60) Provisional application No. 62/738,490, filed on Sep. 28, 2018.

(51) Int. Cl. B60N 2/015

(52) U.S. Cl. CPC B60N 2/0155

(57) ABSTRACT

A latch for a motor vehicle seat assembly and vehicle closure panel includes a housing and a hook assembly pivotably mounted in the housing for pivoting movement between a striker capture position and a striker release position. The hook assembly includes a first member pivotably mounted in the housing for pivoting movement about a first pivot axis and a second member pivotably mounted in the housing for pivoting movement about a second pivot axis. An intermediate spring member is disposed between the first member and the second member. The intermediate spring member imparts a bias between the first member and the second member to bias the second member into engagement with a striker while in the striker capture position. The first member is pivotal relative to the second member about the first pivot axis when the first member pivots toward the striker release position.

### CROSS-REFERENCE TO RELATED APPLICATION

This application claims the benefit of U.S. Provisional Application Ser. No. 62/738,490, filed Sep. 28, 2018, which is incorporated herein by way of reference in its entirety.

### FIELD

The present disclosure relates generally to passenger vehicle seat assemblies. More specifically, the present disclosure is directed to a passenger vehicle seat assembly and to a seat latch therefor.

### BACKGROUND

This section provides background information related to the present disclosure which is not necessarily prior art.

A folding and/or removable passenger vehicle seat assembly is commonly hinged to swing between fixed (latched) and released (unlatched) positions. While in the latched position, the seat assembly is ready for normal use, and while in the unlatched position, the seat assembly is able to be pivoted/folded relative to a floor of the vehicle, such as to allow enhanced freedom for passenger ingress and egress, and/or removed from the vehicle, such as to increase cargo-carrying space within a passenger compartment of the vehicle.

Typically, the passenger vehicle seat assembly includes a latch that is actuatable to allow the seat assembly to be unlatched to move from the latched position to the unlatched position and vice versa. The latch commonly has a metal hook that can be selectively moved from a metal striker (lock pin) capturing position, whereat a striker, fixed to a floor surface of the vehicle, is retained (captured) by the hook, to a striker release position, whereat the striker is released from the hook, thereby allowing the seat to be pivoted and/or removed. While in the striker capture position, the seat must remain fixed in such a manner so as to comply with motor vehicle operational and regulatory requirements.

Although commercially-available seat assemblies and latches therefor are satisfactory to meet all motor vehicle operational and regulatory requirements, a recognized need exists to advance the technology and provide enhanced functionality over an extended useful life, while minimizing the effort required for intended actuation thereof, reducing noise generated by latches while in use, that are reliable and easy-to-use, that are economical in manufacture and assembly, and that minimize package size and weight. Presently, issues remain with regard to the aforementioned needs. For example, friction between the metal hook and metal striker can result in a release effort that is greater than desired, while slop (freedom of movement also referred to as “play” or “freeplay”) between the hook and the striker can result in vibration and noise. Further yet, economies of manufacture and assembly can be adversely affected by having to meet tight tolerances between interconnected components of the latch, as well as with meeting tolerances required between the latch hook and the striker. Additionally, weight remains an issue with all metal components.

In view of the above, there remains a desire to develop alternative seat assemblies and latches therefor which address and overcome limitations associated with known seat assemblies.

### SUMMARY

This section provides a general summary of the disclosure and is not intended to be interpreted as a comprehensive and exhaustive listing of its full scope or all of its aspects, features and structured configurations.

It is an aspect of the present disclosure to provide a seat assembly for a motor vehicle that addresses at least those issues discussed above.

It is a related aspect of the present disclosure to provide a latch for a passenger seat assembly of a motor vehicle that addresses at least those issues discussed above.

It is a related aspect of the present disclosure to provide a latch for a closure panel, such as a vehicle side door, decklid, hood, or interior vehicle closure panel such as for a glove box, or center console, of a motor vehicle that addresses at least those issues discussed above.

It is a related aspect of the present disclosure to provide a latch having a hook assembly that releases a striker with minimal release effort, while providing reliable and repeatable selective (intended, whether manually or via motor driven assistance) actuation of the latch to move from a striker capture to a striker release position when desired.

In a related aspect, the hook assembly is configured to remain in slop-free engagement with the striker, thereby resulting in vibration free, quiet operation of the seat assembly during use of the vehicle, as desired.

In accordance with these and other aspects, a latch for a motor vehicle seat assembly is provided. The latch includes a housing and a hook assembly pivotably mounted in the housing for pivoting movement between a striker capture position and a striker release position. The hook assembly includes a first member and a second member. The first member is pivotably supported for pivoting movement about a first pivot axis and the second member is pivotably supported for pivoting movement about a second pivot axis spaced from the first pivot axis. The first member is pivotal relative to the second member. An intermediate spring member disposed between the first member and the second member imparts a bias between the first member and the second member to bias the second member into engagement with a striker while in the striker capture position, thereby enhancing smooth, quiet, vibration free operation of the latch and seat assembly during use of the vehicle. The first member is pivotal relative to the second member about the first pivot axis when the first member is pivoted toward the striker release position to facilitate smooth, reduced release effort of the hook assembly of latch from the striker.

In a further related aspect, the first member and the second member can be pivotably supported by the housing via separate pivot pins.

In a further related aspect, the intermediate spring member acting between the first member and the second member can be configured to impart a varying spring load during movement of the hook assembly from the striker capture position toward the striker release position, thereby further reducing the release effort of the latch.

In a further related aspect, the intermediate spring member acting between the first member and the second member can have a first end attached to the first member and a second end attached to the second member to impart a bias directly therebetween.

In accordance with another aspect, a primary spring member can be disposed between the housing and the first member to impart a bias on the first member to bias the first member toward the striker capture position.

In accordance with another aspect, the primary spring member can have a first end attached to the housing and a second end attached to the first member to impart a bias directly therebetween.

In accordance with another aspect, the second member can be made of a low friction polymeric material, thereby being lightweight and economical in manufacture, and further having a low coefficient of friction to facilitate sliding against the striker to facilitate a low release effort of the latch and to further reduced vibration and noise between the second member and the striker.

In accordance with another aspect, the first member can be made of a high strength metal material, thereby enhancing durability and robustness of the hook assembly.

In accordance with another aspect, the first member can be provided as at least one generally planar (flat, having generally parallel, planar opposite sides), hook-shaped member.

In accordance with another aspect, the second member can be provided having a pair of generally flat, planar sidewalls spaced in generally parallel relation from one another by a gap, with the first member being disposed for pivotal movement within the gap, such that the sidewalls can act to guide and stabilize the first member during pivotal movement of the first member relative to the second member.

In accordance with another aspect, the first member can include a plurality of generally planar, hook-shaped members disposed in the gap of the second member to increase the load capacity of the latch, while at the same time enhancing economic manufacture of the latch by not having to increase the material thickness of an individual one of the first members, such that the first members can all be made of separate, individual, relatively thin pieces of metal material and then stacked in abutting, mating relation with one another.

In accordance with another aspect, a motor vehicle seat assembly for releasable and/or adjustable fixation to a floor surface of a motor vehicle is provided. The seat assembly includes a cushioned seat surface and frame member supporting the surface with one of a latch or a striker fixed thereto, with the other of the latch or striker being fixed to the floor surface. The latch includes a housing and a hook assembly pivotably mounted in the housing for pivoting movement between a striker capture position, whereat hook assembly captures and retains striker to maintain seat assembly in an in-use state, and a striker release position, whereat hook assembly releases striker to allow seat assembly to be pitched and optionally slid and/or removed. The hook assembly includes first member and a second member. The first member is pivotably mounted in the housing for pivoting movement about a first pivot axis and the second member is pivotably mounted in the housing for pivoting movement about a second pivot axis separate from and spaced from the first pivot axis. An intermediate spring member is disposed between the first member and the second member to impart a bias between the second member and the first member to bias the second member into engagement with the striker while in the striker capture position, thereby enhancing smooth, quiet operation of the latch and seat assembly during use of the vehicle. The first member is pivotal relative to the second member as the first member pivots about the first pivot axis when the first member pivots toward the striker release position, thereby enhancing smooth, quiet, reduced release effort of the latch.

In accordance with another aspect, a method of reducing the release effort of a latch of a seat assembly from a striker capture position, whereat a hook assembly captures and retains a striker to maintain seat assembly in an in-use state, to a striker release position, whereat hook assembly releases the striker to allow the seat assembly to be pitched and optionally slid and/or removed relative to a vehicle floor panel, is provided. The method includes providing a hook assembly of the latch having a first member and a second member, with the second member being configured to engage and lock with the striker while in the striker capture position. Further, configuring the second member of the hook assembly to pivot out of engagement with the striker under a bias of an intermediate spring member in direct response to pivoting movement of the first member causing the bias of the intermediate spring member on the first member.

In accordance with another aspect, the method can further include configuring the intermediate spring member to impart a varying spring load between the first member and the second member during movement of the hook assembly from the striker capture position toward the striker release position.

In accordance with another aspect, the method can further include reducing the noise of the latch while in the striker capture position by biasing and maintaining the second member in constant engagement with the striker while the latch is in the striker capture position under the bias imparted by the intermediate spring member.

In accordance with another illustrative embodiment, there is provided a latch for a motor vehicle closure panel including a striker, the latch including a housing and a hook assembly pivotably mounted in the housing for pivoting movement between a striker capture position, whereat the hook assembly captures and retains the striker to maintain the vehicle closure panel in a closed state, and a striker release position, whereat the hook assembly releases the striker to allow the vehicle closure panel to be moved to an open state. The hook assembly includes a first member and a second member. The first member is pivotably mounted in the housing for pivoting movement about a first pivot axis and the second member is pivotably mounted to in housing for pivoting movement about a second pivot axis, wherein the first pivot axis is spaced from the second pivot axis and the first member is pivotal relative to the second member about the first pivot axis. An intermediate resilient coupling is disposed between the first member and the second member. The intermediate resilient coupling imparts a bias between the first member and the second member to bias the second member into engagement with the striker while in the striker capture position.

In accordance with another illustrative embodiment, there is provided a latch for a motor vehicle closure panel including a striker, the latch including a housing, a hook assembly pivotably mounted in the housing for pivoting movement between a striker capture position, whereat the hook assembly captures and retains the striker to maintain the vehicle closure panel in a closed state, and a striker release position, whereat the hook assembly releases the striker to allow the vehicle closure panel to be moved to an open state. The hook assembly includes a first member and a second member. The first member is pivotably mounted in the housing for pivoting movement about a first pivot axis and the second member is pivotably mounted in the housing for pivoting movement about a second pivot axis, wherein the first pivot axis is spaced from the second pivot axis and the first member is pivotal relative to the second member about the first pivot axis, wherein the first member and the second member are coplanar.

In accordance with another aspect, there is provided a method of reducing the vibration of a striker retained in a striker capture position by a latch, such as a latch for of a seat assembly or a vehicle closure panel. The method includes the steps of: providing a hook assembly of the latch having a first member and a second member, with the second member being configured to pivot into engagement with the striker under a bias of an intermediate resilient coupling to lock with the striker, while in the striker capture position, and configuring the second member of the hook assembly to pivot in direct response to pivoting movement of the first member during movement of the hook assembly from the striker capture position toward a striker release position.

In accordance with a further aspect, the method of reducing the vibration of a striker retained in a striker capture position by a latch can include configuring the intermediate resilient coupling to impart a constant load between the first member and the second member when the hook assembly is in the striker capture position, thereby minimizing the potential for vibration and noise generation therebetween.

In accordance with a further aspect, the method of reducing the vibration of a striker retained in a striker capture position by a latch can include configuring the intermediate resilient coupling to impart a variable load between the first member and the second member as the hook assembly is moved from the striker capture position toward the striker release position to reduce the release effort of the latch.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle equipped with a closure panel and seat assembly having latches constructed in accordance with and embodying the teachings of the present disclosure;

FIG. 1A is another partial perspective view of the motor vehicle equipped illustrating the seat assembly with the latch constructed in accordance with and embodying the teachings of the present disclosure;

FIG. 2 is an exploded perspective view of the latch associated with the seat assembly of the present disclosure;

FIG. 3 is an assembled front perspective view of the latch shown in FIG. 2;

FIG. 4 is a side view of a portion of the seat assembly including the latch shown in a striker capture position;

FIG. 4A is an enlarged view of the encircled area 4A of FIG. 4;

FIG. 4B is an enlarged view of a portion of the latch as shown in FIG. 4 while in the striker capture position;

FIG. 5 is a perspective view illustrating a hook assembly of the latch while in the striker capture position;

FIG. 6 is a view similar to FIG. 5 illustrating the hook assembly while initially opening from the striker capture position toward a striker release position;

FIG. 6A is a side view of the hook assembly as generally shown in FIG. 6;

FIG. 7 is a view similar to FIG. 6 illustrating the hook assembly continuing to open from the striker capture position toward a striker release position;

FIG. 8 is a view similar to FIG. 7 illustrating the hook assembly while continuing to open from the striker capture position toward a striker release position;

FIG. 9 is a view similar to FIG. 8 illustrating the hook assembly in the striker release position;

FIG. 9A is a side view of the hook assembly as generally shown in FIG. 9;

FIG. 10 is a perspective view illustrating a hook assembly of a latch constructed in accordance with another aspect of the disclosure while in the striker capture position;

FIG. 11 is a flow diagram illustrating a method for reducing the release effort of a latch of a seat assembly and a vehicle closure panel from a striker capture position to a striker release position to allow pivotal movement of the seat assembly relative to a vehicle floor panel, while also reducing the vibration of a striker while retained in a striker capture position;

FIG. 12A is a graph illustrating the force of a primary spring member versus time during a latch release sequence;

FIG. 12B is a graph illustrating the force of an intermediate spring member versus time during the latch release sequence; and

FIG. 12C is a graph illustrating the release effort versus time during the latch release sequence.

Corresponding reference numerals, offset by various factors where indicated, are used throughout all of the drawings to identity common components.

### DETAILED DESCRIPTION OF EXAMPLE EMBODIMENTS

In general, example embodiments of a vehicle closure panel, seat assembly and latch therefor, constructed in accordance with the teachings of the present disclosure, will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

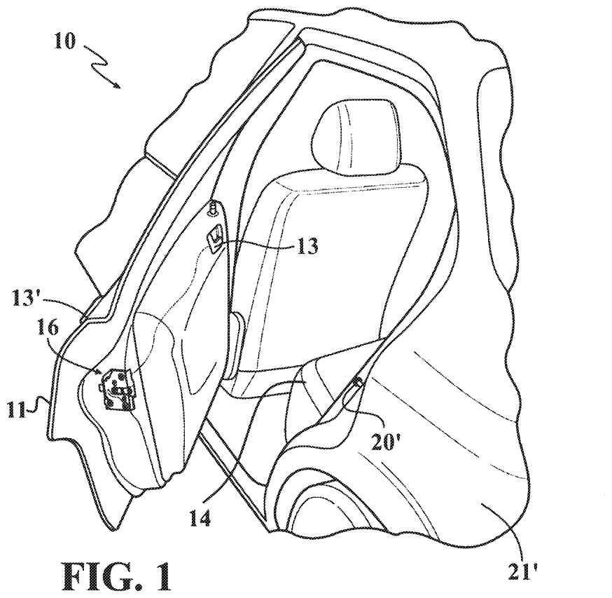

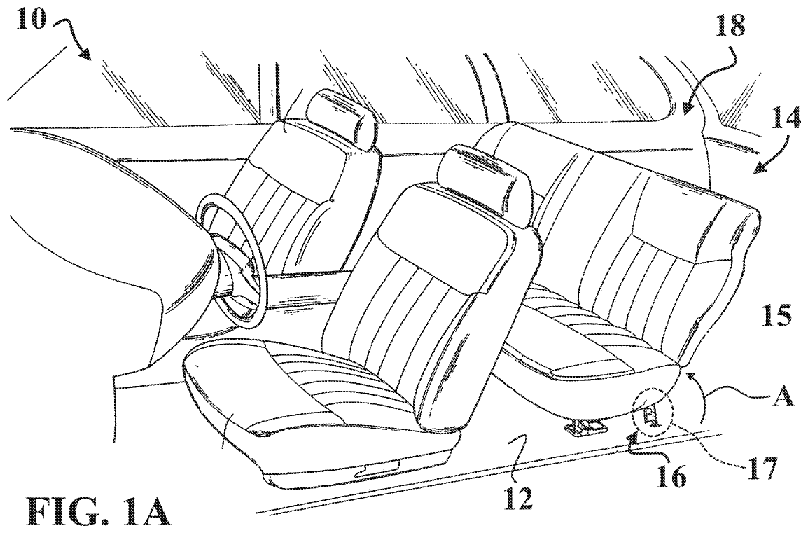

FIGS. 1 and 1A illustrate partial perspective views of a motor vehicle 10 having a vehicle closure panel, shown as a passenger swing door, and referred to hereafter as door 11, by way of example and without limitation, hinged to a vehicle body for movement between closed and open positions. Door 11 includes an inside door handle 13, an outside door handle 13′, and a closure latch assembly, also referred to hereafter as latch assembly, latch mechanism, or latch 16, constructed in accordance with one aspect of the disclosure and positioned on an edge face of door 11. A connection device (shown in dashed line), such as a Bowden cable, by way of example and without limitation, is shown operatively interconnecting latch 16 to inside door handle 13 and outside door handle 13′. As will be detailed, latch 16 includes a latch mechanism configured to releasably latch to a striker 20′ fixed to a vehicle body 21′. While the closure member is illustrated as a vehicle passenger swing door 14, it is to be understood that latch 16, to be described in more detail, can likewise be adapted for use with alternative closure members such as, and without limitation, liftgates, tailgates, hatch doors, sliding doors, trunk lids and/or engine compartment hoods.

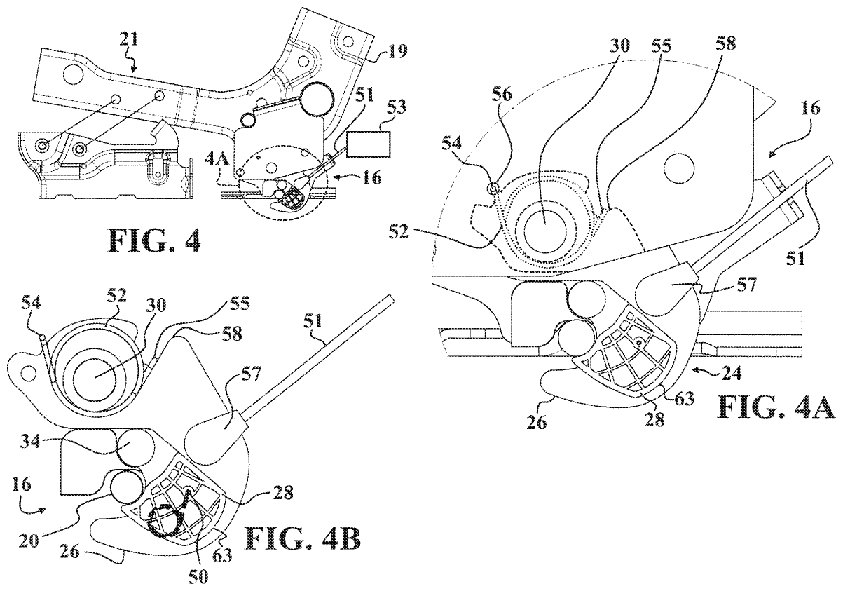

As shown in more detail in FIG. 1A, vehicle 10 further includes a floor panel 12 supporting a seat assembly 14 for pivotal movement thereon and for sliding and/or optional removal therefrom via selective (intentionally actuated) actuation of a latch 16 (separate from latch discussed above for door 14, but embodying the same features, as discussed hereafter, and thus, the discussion hereafter references latch 16 with it to be understood that latch 16 pertains to the same latch used for vehicle closure panel 11 and/or seat assembly 14). Latch 16, by way of example and without limitation, is shown located adjacent a rear region 17 of seat assembly 14, and is further shown being fixed to a rear portion of a frame member 21 of vehicle body 21′ supporting a cushioned seat surface 15, such as to a frame member rear pillar 19 (FIG. 4), of seat assembly 14. Seat assembly 14, upon intentional actuation of latch 16, can be pivoted/folded/pitched in the direction of arrow A to allow enhanced freedom for passenger ingress and egress, and/or slid and optionally removed from the vehicle 10, such as to increase cargo-carrying space within a passenger compartment 18 of the vehicle 10. As will be readily understood by a person possessing ordinary skill in the art, in view of the disclosure herein, the latch 16 is configured to provide zero slop engagement with a locking pin, also referred to as anchor pin or striker 20, thereby minimizing vibration and relative movement therebetween while in a striker capture position and during actuation, and thus, minimizing the generation of noise, as well as to facilitate enhanced, reliable and repeatable, low effort actuation (minimal intended force needed to selectively actuate latch 16), while also being economical in manufacture, having a reduced weight and exhibiting a long and useful life.

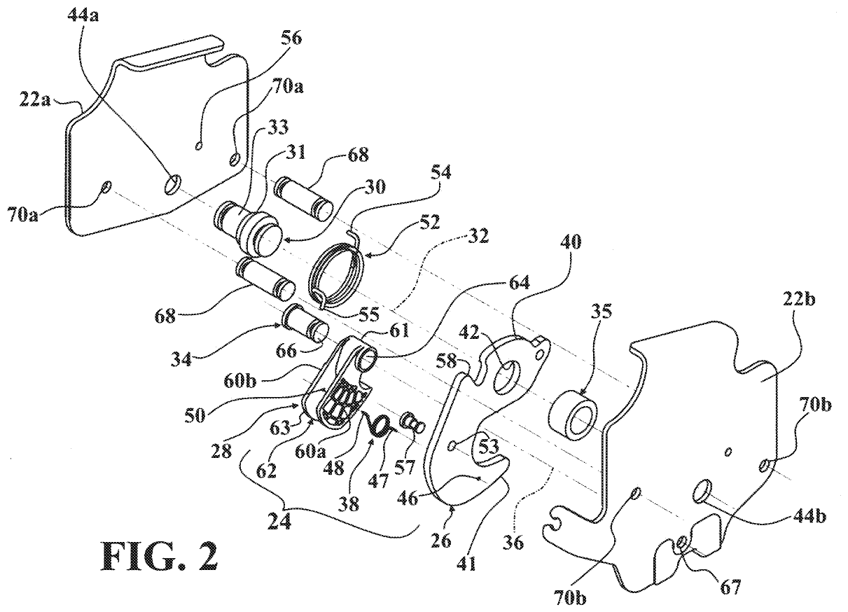

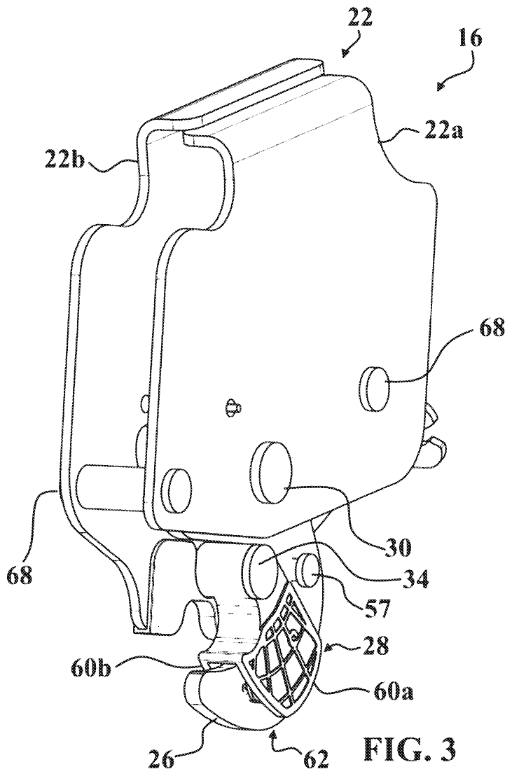

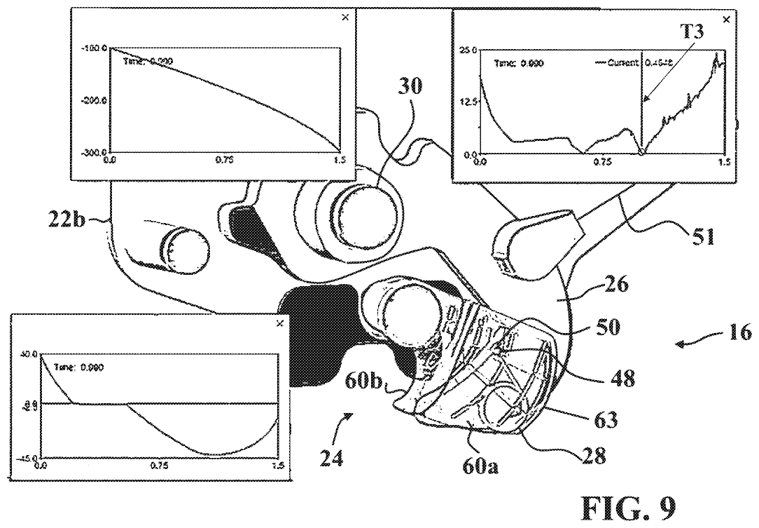

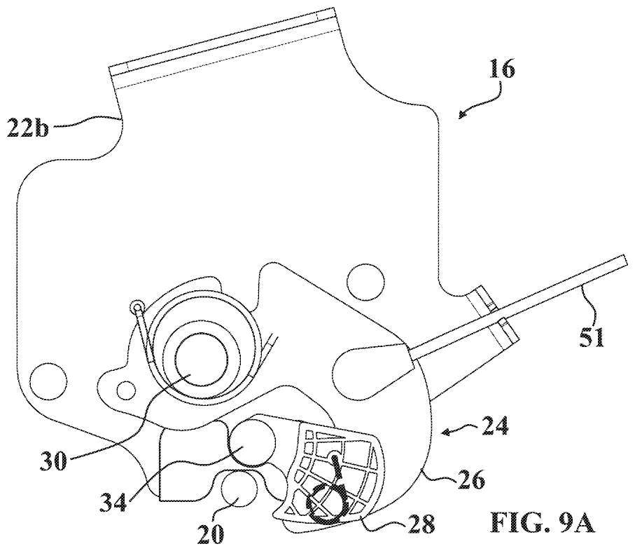

Referring initially to FIG. 2, latch 16 of closure latch assembly 20 is shown having a housing 22, shown by way of example and without limitation as including an inner side bracket, also referred to as inner plate 22a, and an outer side bracket, also referred to as outer plate 22b, and a hook assembly 24 pivotably mounted to and within the housing 22 for pivoting movement between a striker capture position, whereat hook assembly 24 captures and retains striker 20 to maintain door 11 in a closed state and seat assembly 14 in an in-use state (FIGS. 1A, 4 and 5), and a striker release position (FIGS. 9 and 9A), whereat hook assembly 24 releases striker 20 to allow door 11 to be moved to an open state and seat assembly 14 to be pitched in the direction of arrow A (FIG. 1A) and optionally moved via sliding and subsequently removed from vehicle 10. The hook assembly 24 includes a primary hook, also referred to as ratchet, main hook, hook or first member 26 and a secondary hook, also referred to as cinch member, cinch or second member 28. The first member 26 is pivotably mounted in, and shown as being mounted to the housing 22, by way of example and without limitation, such as via a first pin, also referred to as hook pivot pin 30, for pivoting movement about a first pivot axis 32 of hook pivot pin 30, and the second member 28 is pivotably mounted in, and shown as being mounted to the outer plate 22b of housing 22, by way of example and without limitation, such as via a second pin, also referred to as cinch pivot pin 34, for pivoting movement about a second pivot axis 36 of cinch pivot pin 34. The second pivot axis 36 is spaced laterally from the first pivot axis 32, wherein the first and second pivot axes 32, 36 are shown extending parallel with one another. An intermediate resilient coupling member, such as a cinch spring member, also referred to as or intermediate spring member 38, shown as a torsion spring, by way of example and without limitation, is disposed between the first member 26 and the second member 28, wherein the intermediate spring member 38 imparts a bias between the second member 28 and the first member 26 to bias the second member 28 into engagement with the striker 20, 20′ while hook assembly 24 is in the striker capture position, thereby enhancing smooth, vibration free, quiet operation of the latch 16 and seat assembly 14 during use of the vehicle 10. Further yet, the first and second members 26, 28 are pivotal relative to one another, wherein the first member 26 pivots relative to the second member 28 about the first pivot axis 32 when the first member 26 pivots toward the striker release position, thereby further enhancing smooth, reduced release effort of the latch 16.

The first member 26 includes at least one generally flat, planar, hook-shaped member having opposite flat sides in generally parallel relation with one another, such as a stamped, high strength metal member, by way of example and without limitation, and shown in FIG. 2 as a single hook-shaped member 26 having an attachment end 40 and an opposite hook-shaped end 41. The attachment end 40 has an opening 42 sized for receipt of hook pivot pin 30 therethrough, wherein hook pivot pin 30 has opposite ends configured for attachment within openings 44a, 44b of respective inner and outer housing plates 22a, 22b. Hook pivot pin 30 has a journal surface 31 sized for pivoting movement of first member 26 thereon, and further includes a surface 33 configured for receipt of an annular spacer 35 thereon, wherein spacer 35 facilitates maintaining first member 26, and ultimately second member 28, in laterally aligned relation between inner and outer housing plates 22a, 22b for pivotal movement of first member 26 therebetween, as desired. First member 26 is also shown as having a spring retention feature, such as a through opening 46 or otherwise, for operable attachment of a first end 47 of intermediate spring member 38 therein, while an opposite second end 48 of intermediate spring member 38 is configured for operable attachment to second member 28, such as in a through opening 50 therein, by way of example and without limitation. To facilitate selective pivotal actuation of hook assembly 24, first member 26 has an actuation member, such as an actuation rod or actuation cable 51 attached thereto (FIG. 4), shown as being attached via a pin 57 fixed within a through opening 53 located between the attachment end 40 and the hook-shaped end 41, with actuation member 51 being actuatable via an actuator 53 within the door 11 and/or passenger compartment 18, such as via inside and/or outside door handle 13, 13′ (for door 11) and/or a handle, lever, knob, button, or other member operable to selectively actuate (pull) actuation member 51 (for seat assembly 14).

A hook spring member, also referred to as primary spring member 52, is disposed between the housing 22 and the first member 26. A first end 54 of primary spring member 52 is configured for operable attachment to one of the inner and outer plates 22a, 22b, and shown, by way of example and without limitation as being fixed within a through opening 56 of inner plate 22a (FIG. 4A), while an opposite second end 55 of primary spring member 52 is configured for operable attachment to first member 26, shown as being received in abutment with a notch shoulder 58. The primary spring member 52 is shown, by way of example and without limitation, as being a torsion spring that is preloaded to impart a bias on the first member 26 to bias the first member 26 toward the striker capture position.

The second member 28 is shown, by way of example and without limitation, as having a pair of generally flat, planar sidewalls 60a, 60b extending from a first end, also referred to as attachment end 61 to a second end 63, with the sidewalls 60a, 60b being spaced in generally parallel relation from one another by a gap 62. The gap 62 has a generally uniform width extending between the sidewalls 60a, 60b, wherein the width is sized such that first member 26 can be disposed in the gap 62 in slight clearance relation with the sidewalls 60a, 60b, such that first member 26 can pivot freely within gap 62 in clearance relation with sidewalls 60a, 60b and relative to second member 28. In other words, first member 26 is provided in a nested arrangement with second member 28. Second member 28 may be provided to directly contact the striker 20, 20′, while first member 26 may be provided without directly contacting the striker 20, 20′. First member 26 may directly contact second member 28, for example should a vibration of the striker 20, 20′ urge the second member 28 into contact with the first member 26 after overcoming the bias of intermediate spring member 38. First member 26 and second member 28 may be configured such that the members 26, 28 pivot in similar directions of rotation during an operation, such as a cinch operation or a release operation, for example shown as clockwise in the Figures for cinching the striker towards the striker capture position, while counterclockwise for releasing the striker from the striker capture position. Accordingly, first member 26 and second member 28 are able to pivot relative with one another throughout at least a portion of a latch release operation, with intermediate spring member 38 regulating the relative rotation therebetween via the operable spring force of intermediate spring member 38. The attachment end 61 has an opening 64 sized for receipt of cinch pivot pin 34 therethrough, wherein cinch pivot pin 34 has opposite ends, with at least one end 66 being configured for attachment to one of respective inner and outer housing plates 22a, 22b, and shown, by way of example and without limitation as being attached within an opening 67 of outer housing plate 22b. Second member 28 can be constructed of a metal material, but is preferably molded of a low friction polymeric material, thereby being lightweight and economical in manufacture, and further facilitating a low release effort by providing minimal dynamic, sliding friction against striker 20, 20′.

Housing 22 inner and outer plates 22a, 22b can be fixed to one another in any desired fashion, and are shown, by way of example and without limitation, as being attached to one another via a plurality, shown as a pair of pins 68 fixed within corresponding respective openings 70a, 70b of inner and outer plates 22a, 22b. One skilled in the art will readily recognize that other fastening mechanisms could be used, such as threaded fasteners, welding, or otherwise.

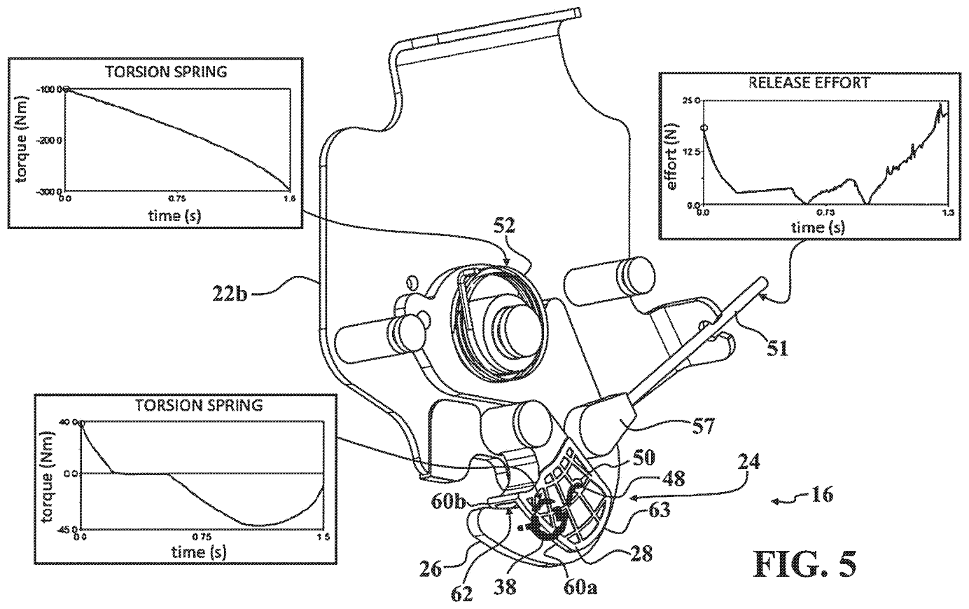

In use, with specific discussion directed to the seat assembly 14, though it is to be recognized that the same discussion pertains equally to door 11, with seat assembly 14 in its locked, in-use position (corresponding to door 11 being in a closed state or position), latch 16 is in its striker capture position (FIG. 5). While in the striker capture position (FIG. 5), primary spring member 52 biases first member in a clockwise (CW) direction, as viewed in FIG. 5, to the striker capture position. As such, first member 26 biases second member 28 against striker 20, with intermediate spring member 38 also acting to bias second member 28 against striker 20, thereby resulting in zero slop between first member 26 and second member 28, and between second member 28 and striker 20 as long as hook assembly 24 remains in the striker capture position. Accordingly, vibration between first and second members 26, 28, and between second member 28 and striker 20 is prevented, and thus, any noise that would result from vibration is kept to a minimum, particularly with second member 28 being constructed of a polymeric (plastic), noise dampening material, relative to metal.

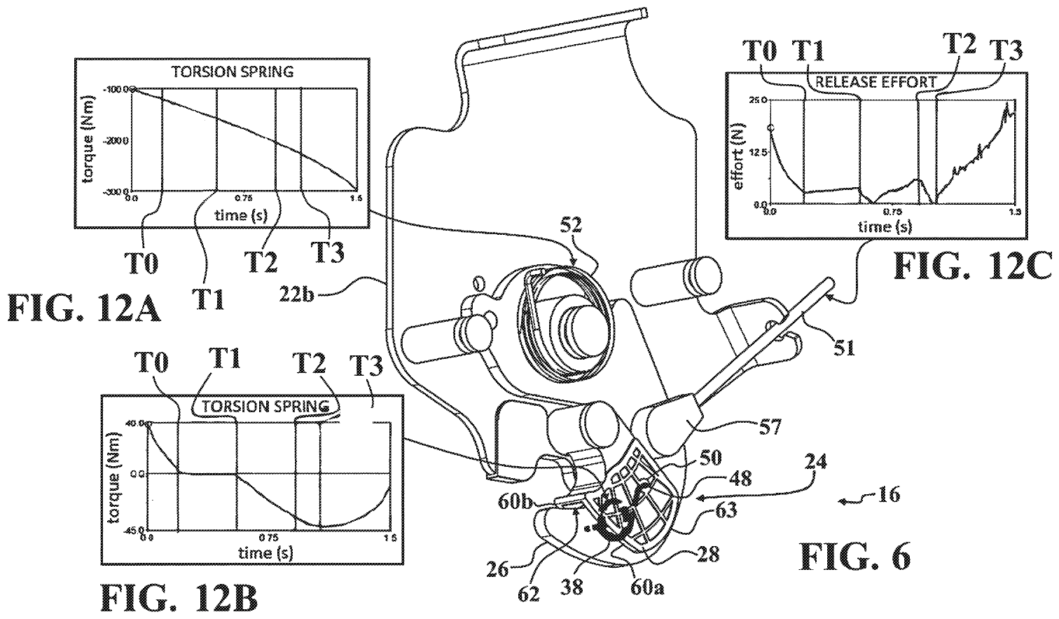

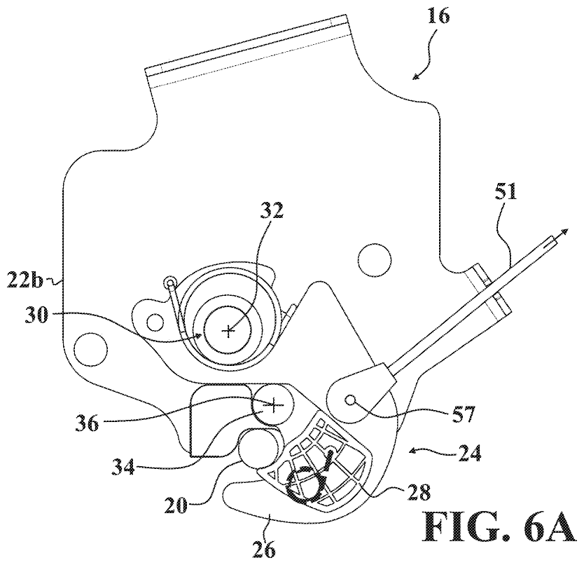

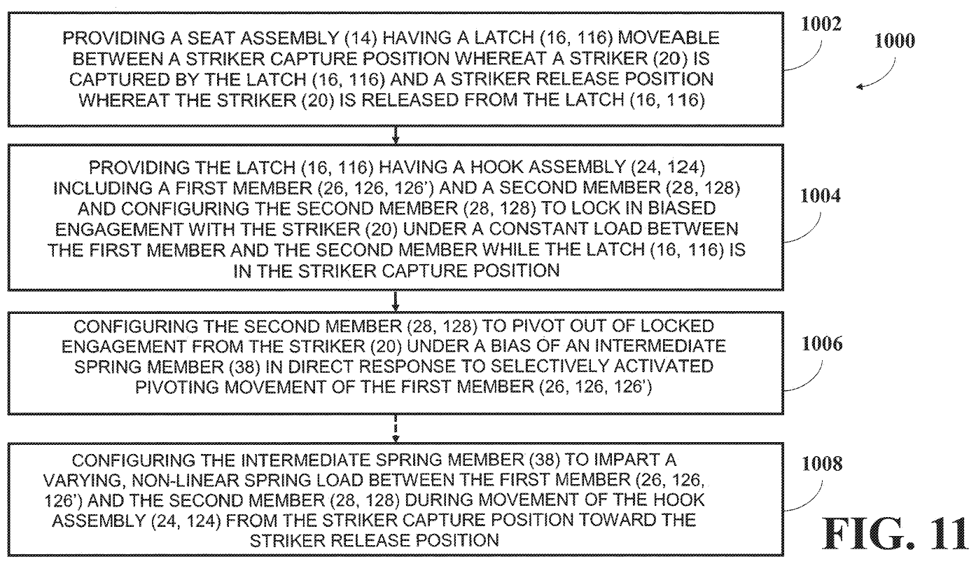

Then, when desired to release seat assembly 14 from its locked state, thereby allowing seat assembly 14 to be pivoted in the direction of arrow A and optionally removed from floor surface 12, actuator 53 can be selectively activated, whereupon actuation member 51 biases first member 26 to pivot against the bias of primary spring member 52 in a counterclockwise (CCW) direction about first pivot axis 32, as viewed in FIGS. 6 and 6A. As first member 26 is pivoting CCW about first pivot axis 32 between time interval 0 to Time0 (FIGS. 12A-12C), intermediate spring member 38 is allowed to relax and expand from its compressed state, due to its internal spring force. As a result of intermediate spring member 38 being attached to both first member 26 and second ember 28 and as a result of intermediate spring member 38 remaining under at least a partially compressed load, as first member 26 is being pivoted away from second member 28 under the actuation force of actuator member 51, intermediate spring member 38 continues to exert a spring bias on second member 28 that causes second member 28 to remain stationary about second pivot axis 36 and in engagement with striker 20. Between time interval Time0 and Time1, as first member 26 continues its pivoting CCW about first pivot axis 32, intermediate spring member 38 assumes a fully expanded state due to its internal spring force. As a result of being attached to both first member 26 and second ember 28, intermediate spring member 38, as a result of being pulled by first member 26 in the CCW direction, exerts a pulling bias on second member 28 as first member 26 continues its pivoting movement in the CCW direction. In turn, second member 28 is caused to pivot CCW under a pulling bias of intermediate spring member 38 about second pivot axis 36, whereupon second member 28 begins disengagement from striker 20.

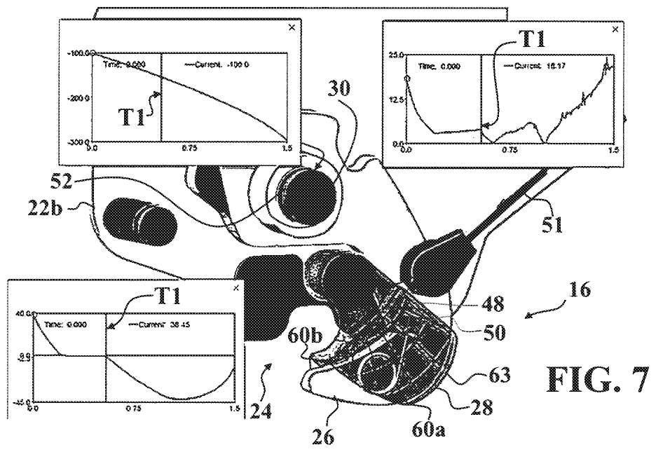

In FIG. 7, as first member 26 continues to pivot CCW about first pivot axis 32, thereby causing second member 28 to continue pivoting CCW about second pivot axis 36, intermediate spring member 38 beings to compress. At Time1, second member 28 temporarily stops, or nearly stops, pivoting concurrently and/or in linear relation with first member 26, whereupon intermediate spring member 38 produces a load direction inversion, which in turn, results in a reduced release effort, as graphically depicted in a “release effort” graph of FIG. 12C (i.e. a negative slope of the release effort after Time1). Accordingly, intermediate spring member 38 imparts a varying spring load between the first member 26 and the second member 28 during movement of the hook assembly 24 from the striker capture position toward the striker release position, thereby reducing the release effort required to actuate latch 16. A controlled disengagement/engagement between the second member 28 and the striker 20 in a manner as illustratively described results which is based upon the interaction of the first member 26 and the second member 28 through coupling with the intermediate spring member 38 (e.g. a resilient coupling).

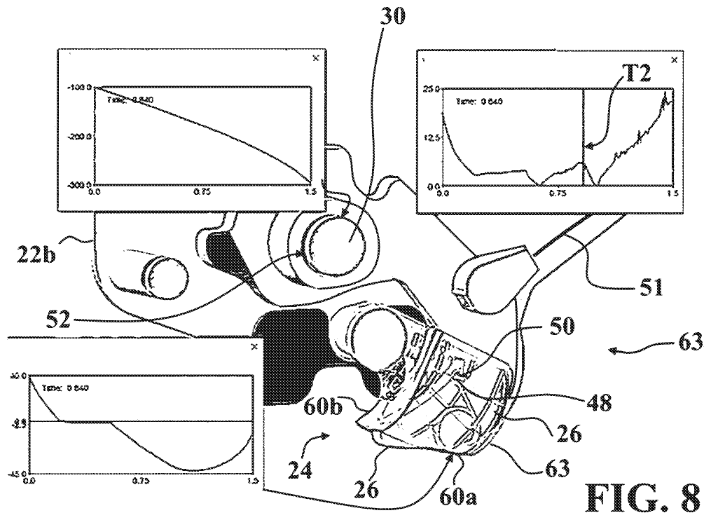

In FIG. 8, continued pivotal movement of first and second members 26, 28 is illustrated between Time 1 and Time 2, and in FIG. 9, continued pivotal movement of first and second members 26, 28 is illustrated between Time 2 and Time 3, whereupon second member 28 becomes fully disengaged from striker 20, such that seat assembly 14 can be pivoted in the direction of arrow A and optionally removed from floor surface 12.

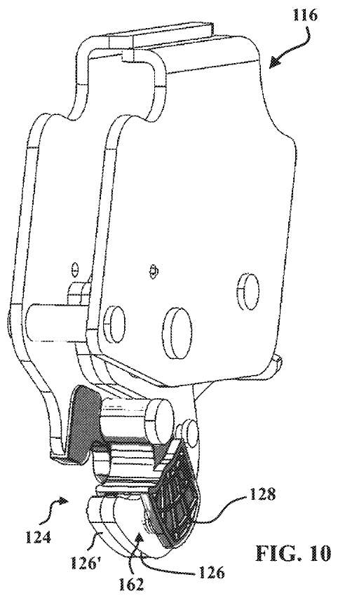

In FIG. 10, a latch 116 constructed in accordance with another aspect of the disclosure is shown, wherein the same reference numerals, offset by a factor of 100, are used to identify like features.

Latch 116 is similar to latch 16; however, latch 116 is provided for heavier duty use via modification to first member 126. First member 126 can be constructed of an increased thickness metal, and to facilitate manufacture, can include a plurality, shown as a pair of generally planar plates 126, 126′ in side-by-side abutting relation with one another. Accordingly, the effective thickness of first member is doubled relative to first member 26 discussed above. It is to be recognized that gap 162 in second member 128 is suitably increased in width to receive the pair of first members 126, 126′ for pivotal movement therein. Otherwise, latch 116 functions the same as discussed above for latch 16, and thus, no further discussion is believed necessary.

In accordance with another aspect, as shown in FIG. 11, a method of reducing the release effort of a latch 16, 116 of a door 11 and/or a seat assembly 14 from a striker capture position to a striker release position to allow pivotal movement of the door 11 from a closed state to an open state and to allow pivotal movement of the seat assembly 14 relative to a vehicle floor panel 12 is provided. The method includes providing a hook assembly 24, 124 of the latch 16, 116 having a first member 26, 126, 126′ and a second member 28, 128 being pivotal relative to one another, with the second member 28, 128 being configured to lock with a striker 20, 20′ while in the striker capture position. Further, configuring the second member 28, 128 of the hook assembly 24, 124 to pivot out of engagement with the striker 20, 20′ under a bias of an intermediate spring member 38 in direct response to pivoting movement of the first member 26, 126, 126′. Further yet, the method can include configuring the intermediate spring member 38 to impart a varying, non-linear spring load between the first member 26, 126, 126′ and the second member 28, 128 during movement of the hook assembly 24, 124 from the striker capture position toward the striker release position.

In accordance with another aspect, the method can further include reducing the noise of the latch 16, 116 while in the striker capture position by biasing the second member 28, 128 into engagement with the striker 20, 20′ via the intermediate spring member 38 while the latch 16, 116 is in the striker capture position.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example detection system can likewise be implemented into many other systems to control one or more operations and/or functions.

What is claimed is:

1. A latch for a motor vehicle seat assembly and vehicle closure panel, comprising:
a housing;
a hook assembly pivotably mounted in the housing for pivoting movement between a striker capture position, whereat said hook assembly captures and retains a striker to maintain the motor vehicle seat assembly in an in-use state and the vehicle closure panel in a closed position, and a striker release position, whereat said hook assembly releases the striker to allow the motor vehicle seat assembly to be pitched and optionally slid and/or removed and vehicle closure panel to be moved to an open position, said hook assembly having a first member supported for pivoting movement about a first pivot axis and a second member supported for pivoting movement about a second pivot axis, said first pivot axis being spaced from said second pivot axis and said first member being pivotal relative to said second member; and
an intermediate spring member disposed between said first member and said second member, said intermediate spring member imparting a bias between said second member and said first member to bias said second member into engagement with the striker while in the striker capture position.

2. The latch of claim 1, wherein said intermediate spring member imparts a varying spring load between said first member and said second member during movement of the hook assembly from the striker capture position toward the striker release position.

3. The latch of claim 2, wherein said intermediate spring member has a first end attached to said first member and a second end attached to said second member.

4. The latch of claim 1, wherein said first member and said second member are pivotably supported by said housing.

5. The latch of claim 1, further including a primary spring member disposed between said housing and said first member, said primary spring member imparting a bias on said first member to bias said first member toward said striker capture position.

6. The latch of claim 1, wherein said the second member is polymeric.

7. The latch of claim 6, wherein said the first member is metal.

8. The latch of claim 1, wherein said second member has a pair of sidewalls spaced from one another by a gap, said first member being disposed in said gap.

9. The latch of claim 8, wherein said first member includes at least one hook-shaped member.

10. The latch of claim 9, wherein said the first member includes a plurality of separate hook-shaped members.

11. A seat assembly for a motor vehicle, comprising:
a cushioned seat surface;
a frame member supporting said cushion seat surface;
a latch operably attached to said frame member, said latch having a housing and a hook assembly mounted to said housing for pivoting movement between a striker capture position, whereat hook assembly captures and retains a striker to maintain said seat assembly in an in-use state, and a striker release position, whereat said hook assembly releases the striker to allow the seat assembly to be pitched and optionally slid, said hook assembly having a first member and a second member, said first member being mounted in the housing for pivoting movement about a first pivot axis and said second member being mounted in the housing for pivoting movement about a second pivot axis, said first pivot axis being spaced from said second pivot axis and said first member being pivotal relative to said second member about said first pivot axis; and
an intermediate spring member disposed between said first member and said second member, said intermediate spring member imparting a bias between said second member and said first member to bias said second member into engagement with the striker while in the striker capture position.

12. The seat assembly of claim 11, wherein said intermediate spring member imparts a varying spring load between said first member and said second member during movement of the hook assembly from the striker capture position toward the striker release position.

13. The seat assembly of claim 11, wherein said intermediate spring member has a first end attached to said first member and a second end attached to said second member.

14. The seat assembly of claim 11, further including a primary spring member disposed between said housing and said first member, said primary spring member imparting a bias on said first member to bias said first member toward said striker capture position.

15. A method of reducing the release effort of a latch of a seat assembly and vehicle closure panel from a striker capture position to a striker release position to allow pivotal movement of the seat assembly relative to a vehicle floor panel or to allow the vehicle closure panel to move from a closed position to an open position, comprising:
providing a hook assembly of the latch having a first member and a second member, with the second member being configured to lock with a striker while in the striker capture position; and
configuring the second member of the hook assembly to pivot out of engagement with the striker under a bias of an intermediate spring member in direct response to pivoting movement of the first member.

16. The method of claim 15, further including configuring the intermediate spring member to impart a varying spring load between the first member and the second member during movement of the hook assembly from the striker capture position toward the striker release position.

17. The method of claim 15, further including reducing the noise of the latch while in the striker capture position by biasing the second member into engagement with the striker while the latch is in the striker capture position.

18. A method of reducing the vibration of a striker retained in a striker capture position by a latch, comprising:
providing a hook assembly of the latch having a first member and a second member, with the second member being configured to lock with the striker while in the striker capture position; and
configuring an intermediate resilient coupling member to impart a constant load between the first member and the second member when the hook assembly is in the striker capture position to bias the second member into engagement with the striker.

19. The method of claim 18, further including configuring an intermediate resilient coupling member to impart a variable load between the first member and the second member during movement of the hook assembly from the striker capture position toward a striker release position.

20. The method of claim 18, further including providing the second member being polymeric.
